(19) United States
(12) Patent Application Publication
(10) Pub. No.: US 2026/0349668 A1
(43) Pub. Date: Nov. 5, 2026

(54) AI-DRIVEN, USER-CENTRIC SOFTWARE QUALITY IMPROVEMENT

(71) Applicant: GOOGLE LLC, Mountain View, CA (US)

(72) Inventors: Shashwat Lal Das, San Francisco, CA (US); Prithwish Mukherjee, Mountain View, CA (US); Henley Kuang, Mountain View, CA (US); Prashant Gupta, Mountain View, CA (US)

(21) Appl. No.: 19/195,428

(22) Filed: Apr. 30, 2025

(51) Int. Cl. G06F 8/33; G06V 20/64

(52) U.S. Cl. CPC G06F 8/33; G06V 20/64

(57) ABSTRACT

Implementations described herein relate to retrieving unstructured inputs, including user feedback (negative, neutral, and/or positive), from external sources and source code event inputs from internal sources. These inputs can be incorporated into a generative model prompt to condition generative models. The generative model output can map user feedback to source code events, and the results can be rendered on output devices. This enables the identification of user-perceived quality issues in software applications. Implementations described herein can be used to quickly detect regressions, identify root causes of user problems, and/or prioritize improvement opportunities.

### BACKGROUND

The field of software development has long sought effective methods for gauging and enhancing product quality. A traditional approach relies on telemetry-based proxy metrics, such as crash rates and latency, to assess and improve software products. Another common technique involves the monitoring of user feedback systems. However, both of these approaches have limitations.

Telemetry-based proxy metrics, while easily quantifiable, often fail to capture the nuances of user experience. These metrics, while useful for identifying technical issues, do not necessarily correlate with user satisfaction or perceived quality. For example, a software application may exhibit low latency and few crashes, yet users may still find it difficult to use or lacking in essential features. The focus on these proxy metrics can lead to a disconnect between the developers' perception of quality and the actual user experience.

User feedback monitoring systems offer a more direct approach to understanding user sentiment. However, such systems are often limited in scope and may not capture the full range of user opinions and experiences. These systems typically aggregate feedback from specific forums or channels, neglecting other potential sources of information, such as user conversations on social media, direct feedback submitted to the developer, and surveys hosted within the product. Furthermore, these systems are often geared toward handling incidents or new issues rather than providing a comprehensive approach to product development. They lack the deep integration with internal development systems, documentation, debugging tools, and deployment information that is needed to address underlying problems and improve the overall user experience.

A significant deficiency in the existing art is the difficulty in translating user feedback into actionable insights for developers. User feedback is often unstructured and subjective, making it challenging and/or labor-intensive to identify and prioritize the most critical issues. This lack of a systematic approach to incorporating user feedback into the development process can lead to a decline in user-perceived quality over time, as developers focus on easily quantifiable metrics rather than addressing the underlying user needs and pain points.

Therefore, there exists a need for an improved method and system for assessing and enhancing software product quality that overcomes the limitations of existing telemetry-based proxy metrics and user feedback monitoring systems. Such a method should prioritize true user experience improvements, provide a scalable platform for capturing the live state of true quality, and enable rapid and quantifiable improvements based on user-perceived quality issues.

### SUMMARY

Some implementations disclosed herein are directed to using self-debate to train and/or fine-tune generative models. This may include implementing a turn-based dialog between two or more “debaters” until a termination condition is satisfied, including assembling a first prompt to generate first output supporting a first position and assembling a second prompt to generate second output supporting a second position. The first and second prompts may also include prior outputs, if present, and the first and second positions may be mutually exclusive and/or contradictory. The first and second prompts are processed using one or more generative models to generate the first and second outputs. After the termination condition is satisfied, a transcript of the turn-based dialog may be used, e.g., by a “judge,” to determine an outcome that indicates whether the first or second position prevailed, and one or more of the generative models are trained based on the outcome.

Various implementations are described herein for leveraging external and/or unstructured data sources to improve user-perceived product quality. More particularly, but not exclusively, some implementations relate to AI-powered true quality platform (TQP) solutions for gathering, integrating, and synthesizing data from distinct sources to assess and improve product quality and user-perceived quality.

Some implementations disclosed herein are directed to using generative model(s) to process unstructured and/or external data sources and map the resulting generative model output(s) to internal and/or structured data sources. In various implementations, one or more unstructured inputs may be retrieved from one or more external data sources, and one or more source code event inputs may be retrieved from one or more internal data sources. One or more of the unstructured inputs and one or more of the source code event inputs are incorporated into a generative model input prompt as context for the input prompt. One or more commands are incorporated into the generative model prompt, wherein the one or more commands are configured to condition one or more generative models to generate generative model output that maps feedback from one or more of the unstructured inputs to information about one or more respective source code events of one or more of the source code event inputs. One or more output devices are caused to render perceptible output that conveys one or more aspects of the generative model output.

Implementations disclosed herein can mitigate (e.g., eliminate) various drawbacks with current techniques. For example, the reliance on easily quantifiable but imperfect proxy metrics can be reduced, enabling a more direct focus on true user-perceived quality, leading to more meaningful improvements in user experience. As another example, the limitations of user feedback monitoring systems in scope and integration with internal development systems can be overcome, enabling the system to synthesize both internal and external data to provide a holistic view of product quality and detect regressions and identify the underlying causes more rapidly. As another example, the AI-driven analysis employed by the platform can minimize developer bias and ensure a more objective assessment of product quality.

As a non-limiting example of some implementations disclosed herein, consider a scenario where a user reports through social media that they are unable to cast music from their smart phone to their smart speaker, mentioning the specific model numbers of both devices and including a screenshot of a configuration software application from their smart phone showing a “connection error.” Concurrently, the development team of the configuration software application releases an update containing changes to the Bluetooth connection protocols used for casting. Techniques described herein may retrieve this unstructured input from social media, identify its negative sentiment, and categorize it under “Media Casting Issues.” Additionally, techniques described herein may retrieve the structured data regarding the recent configuration software application update from an internal source, such as a log of bugs maintained by the developer. The generative model, when prompted with both the user's social media post and the details of the configuration software update, correlates the update with the reported casting issue, generating an output that suggests a potential incompatibility introduced by the updated Bluetooth protocols. This output is then rendered on a dashboard, highlighting a potential root cause (the configuration software application update) and providing a direct link to the user's original social media post and the commit logs of the relevant code change, thus enabling rapid investigation and resolution by the development team.

### BRIEF DESCRIPTION OF THE DRAWINGS

FIG. 1 schematically illustrates an example environment in which aspects of the disclosure may be practiced.

FIG. 2 schematically shows an example of cooperation between various components to carry out aspects of the disclosure.

FIG. 3 depicts an example report that may be rendered and/or presented by a client device.

FIG. 4 depicts an example method performed by a true quality analysis system, according to various implementations.

FIG. 5 depicts an example method performed by a true quality analysis system, according to various implementations.

FIG. 6 is a block diagram of an example computer system.

### DETAILED DESCRIPTION

The present disclosure relates to a platform, sometimes referred to as an AI-Powered true quality platform (TQP), that can provide access to raw or augmented inputs and findings through a variety of textual, analytic, and semantic APIs. The APIs can include conventional querying (by ID, text, structured slice, etc.) and semantic querying (by description, theme, etc.). Such a platform can have a wide application programming interface (API) surface and can connect with a tool, platform, or service compatible with the supported APIs.

A user interface (UI) can be based on the platform. The UI can enable an end-to-end workflow to improve true quality (TQ). Such a workflow can include one or more of: understanding or quantifying TQ trends and improvement opportunities; investigating trends to determine if TQ is improving or regressing, and why; understanding specific true quality improvement opportunities (TQIOs) to determine what the improvement opportunity (IO) is, which users would benefit and how much, etc.; creating true quality improvement plans (TQIPs) such that, in case of a regression, there is a potential culprit change that can be rolled back or some area that should be investigated to understand the root cause to determine if communication with users or escalation should take place or to determine if there is a suggested code or User Experience (UX) change that can be applied directly; or estimating TQ impact of a change to determine how much a change improves or regresses TQ or how much difference a fix actually makes. The findings can be focused on UX issues, which can also represent improvement opportunities. In some implementations, findings, improvement opportunities, and defects can be synonymous.

The TQP can be useful across most stages of a software development workflow.

The platform might reduce reliance on logging by understanding TQ without conventional telemetry, in which extensive logging is required to understand software quality and usage. Traditional techniques can limit understanding of quality based on the quality of logging or may not account for behaviors that are difficult or impossible to log. The TQP can present TQ from users'self-reporting, and user reports might cover a comprehensive set of issues, even the hard-to-log cases. As such, the TQP can represent an evergreen platform for quality which makes up for gaps in logging and presents quality from the user perspective.

The platform can align quality with the user experience by addressing incorrectness and bias in measuring quality where software quality is measured using bespoke metrics, which in turn rely on bespoke logging. Metrics and logging might exhibit biases, gaps, and correctness or implementation issues. A proxy metric for stability can be defined as the average rate of app crashes but ignore app hangs, not opening, etc., which are user-perceivable stability issues but may not strictly qualify as a crash. Defining quality around user reports, rather than a developer-chosen definition, might expand a view of quality to cover every user-meaningful UX issue, grounded in real user feedback, reducing developer-introduced incorrectness or incompleteness in definitions and measurement. Synthesizing this data and producing measurements using AI, rather than a developer, might yield objectivity in the TQ presented.

In some implementations, the TQP can automatically produce a prioritized list of objective TQ issues, as a starting point for the most impactful problems to work on, which can be useful for roles in software development.

The TQP can quickly detect if something broke by identifying regressions where telemetry signals might fail to capture all aspects of TQ and therefore lead to false negatives or false positives. The TQP can process true quality inputs (TQIs) with low latency and can automatically identify any TQ regression through trend and semantic analysis using AI. A regression of a feature, along with a description and estimated timeline, might be identified. Alerts from telemetry-based monitoring can be replaced with a reduced occurrence of false positives or false negatives. These descriptions can also be more descriptive than telemetry alerts.

The TQP might quickly respond to escalations, Public Relations (PR), and safety concerns. The TQP can highlight sensitive problems (e.g. safety or harassment issues) or have PR concerns (e.g. reported on a high-visibility forum or by a high-profile user), the same way as other regressions. Such issues might not be detected by telemetry-based monitoring solutions that rely on system signals rather than user conversations about the system.

The platform might provide all the necessary information to understand an improvement opportunity, where, for an issue or improvement opportunity that is flagged, the UI can present TQIO details and links to other flows to provide further detail.

The platform can connect with internal tracking systems, e.g., to retrieve what are referred to herein as “source code event inputs.” The TQP can connect with an internal tracking system and associates TQIOs found through TQP with existing issues in the tracker, using a similarity search between the description of the TQIO and descriptions of issues in the tracker. Linking TQIOs with existing issues can focus developer attention on new/untracked TQIOs or keep tabs on the status of addressing the TQIO using the tracking issue. The TQIO might provide a way to create a tracking issue for untracked issues.

The platform can provide impact assessment and prioritization. The TQP might calculate an impact for each TQIO based on its nature, and the related TQIs'sentiment and volumes. This can provide a signal on the TQIO's Return on Investment (RoI), which can add clarity and speed up decision-making. The platform can provide a prioritization recommendation which can be used to set the priority of a tracking issue.

The TQP can provide time series trends for the TQIO. The platform might determine how prevalent the TQIO are over time by finding all relevant TQIs from the database and breaking down their volumes over time, using similarity search of the descriptions in TQIO and the TQI or a machine learning (ML)-based classification of each TQI to TQIO.

The platform can allow debugging and resolution of TQIOs. The TQP can connect each TQIO with various other tools and services to help kick off the improvement process, debugging tools for root-causing the problem, or a code editor or suggested change that would update the system to address the TQIO.

The TQP might identify potential culprit changes for a problem. The TQP can connect with internal systems that keep a record of a product's change history, including each change's description, timelines, or affected source code. The platform can map each TQI or new TQIO to a change with similar timelines and semantics to highlight the connections between the user-universe and the developer-universe that the TQP facilitates. The TQP allows for evaluating the TQ impact of a user-visible change, by expressing a user problem/TQIO that a change or feature is trying to address.

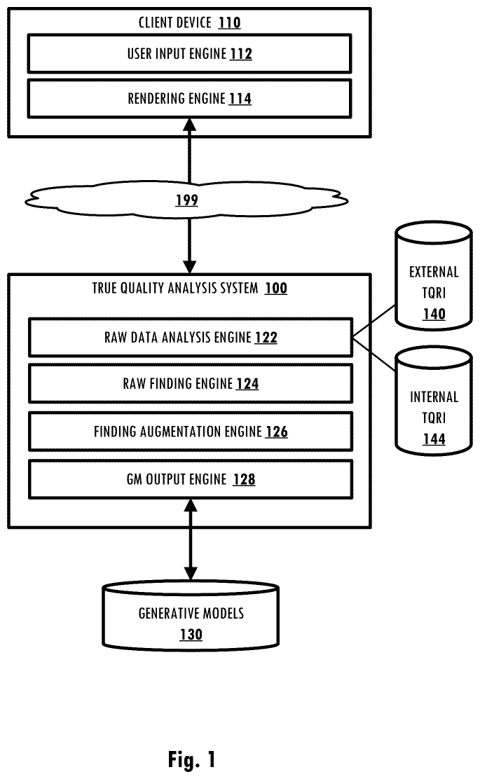

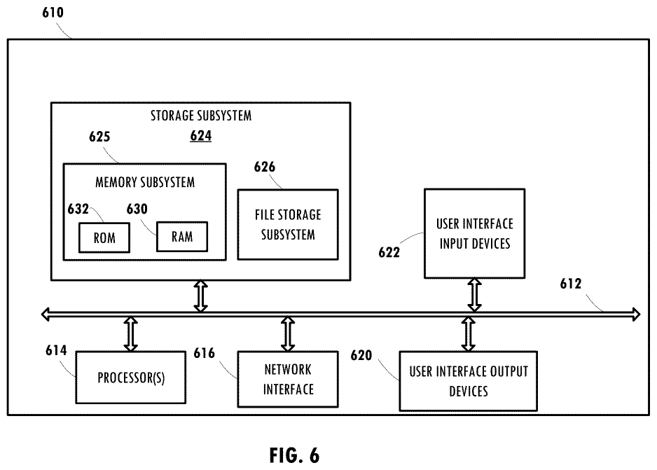

FIG. 1 schematically depicts an example environment in which selected aspects of the disclosure may be implemented. Any of the various components depicted in FIG. 1 may be implemented using any combination of hardware or software. For example, any of these components may be implemented as software modules that execute on one or more processors in one or more computer systems (e.g., the computer system(s) depicted in FIG. 6). As another example, any of these components may be implemented by one or more computer systems located in the same physical location, and/or by one or more computer systems in two or more physical locations. Similarly, any two or more of these components may be combined into a single apparatus, and the various functions described herein may be performed by the single apparatus or divided up among different apparatuses (e.g., in a distributed fashion).

A true quality analysis system 100 is depicted in FIG. 1 as an example of one of many suitable environments in which selected aspects of the present disclosure may be practiced. True quality analysis system 100 may include various engines that may be implemented using any combination of hardware and software. In FIG. 1, for instance, true quality analysis system 100 includes a raw data analysis engine 122, a raw finding engine 124, a finding augmentation engine 126, a GM output engine 128, and generative model(s) 130. True quality analysis system 100 may additionally include any other components not depicted in FIG. 1.

Client device 110 may be connected to true quality analysis system 100 using one or more networks 199, such as one or more local area networks, wide area networks, the Internet, etc. Client device 110 may take various forms. These may include, but are not limited to, mobile devices that include one or more processors and one or more memories (e.g., smartphones, tablet computers, wearable devices, etc.), personal computers (PCs), etc. Client device 110 includes a user input engine 112 that allows a user of client device 110 to provide various inputs to client device 110 (e.g., by typing into one or more input fields). Client device 110 also includes a rendering engine 114 that allows client device 110 to render various types of content (e.g., text, graphics, video, audio, and/or any combination thereof) for presentation to a user of client device 110. This content may be rendered, for example, on a screen of client device 110. In some cases, the content may be interactive and may provide the ability for a user to provide input via client device 110 (e.g., via a touchscreen display, via a mouse or other pointing device, etc.).

As a component of true quality analysis system 100, raw data analysis engine 122 may be configured to retrieve, from a variety of different data sources, various types of inputs about a software application. The software application may be based on (e.g., compiled from) source code controlled by a developer entity (e.g., person, group, organization, company).

Some data sources may include external true quality raw inputs (TQRI) 140. External TQRI 140 is so named because it comes from data sources that are external to (e.g., not under the control of or managed by) the developer entity. External TQRI 140 often may be “unstructured” and/or “un-curated” in that it does not necessarily conform to any predefined template or format (e.g., is unpredictable in form), and can include various modalities of data such as text, audio, video, images, etc. External TQRI 140 may include negative, neutral, and/or positive feedback about products such as the software application that is based on the source code controlled by the developer entity. External TQRI 140 may include myriad different forms of data, such as posts to public web sites, social media posts, posts to news aggregators, posts to online forums, captured screenshots, audio and/or video recordings (e.g., podcasts) of users providing feedback about the true quality of the software application (alone or as part of a conversation), application feature requests, etc.

Other data sources may include internal TQRI 144. Internal TQRI 144 is so named because the data sources are “internal” to (e.g., controlled, hosted, or managed by) the developer entity. Internal TQRI 144 may include curated and/or structured data, e.g., data that is predictable in form, such as internal bug reports, help center records, code check-in comments (e.g., statements describing edits made to source code), customer satisfaction (CSAT) metrics, “PUNTs” (e.g., problems for which analysis and/or solutions are deferred to a later date), etc.

Raw data analysis engine 122 may leverage generative model(s) 130 to process external TQRI 140 in manner(s) that is source agnostic. In addition, raw data analysis engine 122 may normalize and summarize unstructured external TQRI 140. Such normalization may include, for example, generating textual summaries of varying lengths, such as 4, 8, 16, 32, and 64 words, to capture the most pertinent information of individual inputs of external TQRI 140 while managing context window limitations. In addition, the data points may be grouped, for example, based on the source, such as a particular social media application and/or social news aggregator, such that an analysis may be independently generated for each data source to manage the context. These methods of input collection lead to generation of true quality augmented inputs (TQAIs).

Raw finding engine 124, in a “finding generation” process, may incorporate the TQAIs into a generative model input prompt, along with one or more commands. The commands can be configured to condition generative models 130 to generate true quality raw findings (TQRFs). TQRFs may identify observations related to true quality of the software application. These observations can include, for instance, user pain points, satisfaction points, feature requests, regression (e.g., a code change that “unfixes” a previous fix), questions, general perceptions of the software application, etc.

Finding augmentation engine 126 may be configured to process TQRFs to generate true quality augmented findings (TQAFs). Additionally or alternatively, finding augmentation engine 126 may be configured to process TQAFs to update them. In either case, the augmentation may add any useful information such as more specific descriptions than were contained in TQRFs, timing, trends, potential culprits/root causes, types of users affected, sentiment, relevant source code changes (which may have led to a new trend of users complaining about a feature of the software application), changes to relevant proxies/internal metrics (e.g., latency, impressions, clicks, engagement, crashes, etc.), and so forth. In some implementations, TQAI may identify trends in the negative (or positive) feedback of the external TQRI 140 and/or map source code event inputs of the internal TQRI 144 with temporal starting points of these trends.

GM output engine 128 may be configured to use generative model(s) 130, in whole or in part, to generate information to respond to requests received by true quality analysis system 100. In some implementations, GM output engine 128 can oversee the process of producing several candidate responses to a specific prompt by leveraging generative model(s) 130.

Generative model(s) 130 may take various forms, such as a single-modal or multimodal large language model (LLM), vision-language model (VLM), and/or other type of generative model. Generative model(s) 130 may have various types of architectures, such as encoder only, encoder-decoder, decoder-only, etc. In some implementations, generative model(s) 130 may include diffusion model(s). Non-limiting examples of generative models may include, but are not limited to, Gemini, Gemini 2.0, Flamingo, and so forth. Generative models may have hundreds of millions, if not hundreds of billions, of parameters.

Generative models executed on the cloud can leverage significantly larger computational resources and datasets compared to those on a local device. This allows cloud-based models to be trained with many more parameters, leading to a greater capacity for learning complex patterns and relationships in the training data. Consequently, cloud-based generative models may exhibit superior performance and generate more realistic or diverse outputs than their locally executed counterparts. On the other hand, smaller generative models, particularly those hosted locally on a client device, may offer enhanced privacy due to on-device data processing, reduced latency because they eliminate network transit time, and improved accessibility even without continuous network connectivity. Furthermore, running models locally can decrease reliance on centralized cloud infrastructure, offering greater control and potentially lower operational costs.

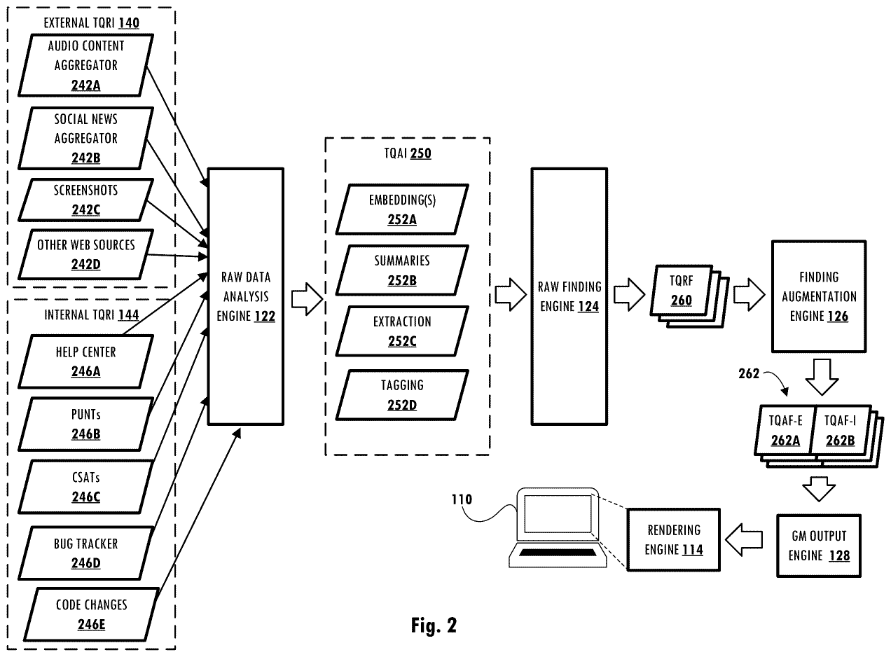

FIG. 2 schematically depicts an example of how various components of FIG. 1 may cooperate to carry out selected aspects of the present disclosure. Starting at left, raw data analysis engine 122 retrieves external TQRI 140 and internal TQRI 144 as described previously. In some implementations, various data connectors may be implemented to fetch the various types of data of TQRI 140 and store them in a TQRI database (not depicted) for reduced latency. As shown in FIG. 2, external TQRI may include unstructured inputs from various sources, such as an audio content aggregator 242A, a social news aggregator 242B, screenshot(s) 242C captured by users to document their negative experiences with the software application (e.g., to show an error message or crash), other web sources 242D, and so forth.

These raw inputs may be encoded, normalized, and/or summarized by raw data analysis engine 122. For example, raw data analysis engine 122 may use one or more generative models 130 to perform summarization, classification, extraction, normalization, encoding, dimensionality reduction, sentiment analysis, and/or utility analysis of TQRI 140/144, and generate TQAI 250 as output. TQAI 250 may include, for instance, user feedback captured in various modalities of data (e.g., text from news aggregator 242B, screenshot(s) 242C, audio 242A, videos, forum discussions, survey results, etc.), that has been normalized as text.

Internal TQRI 144 may include various curated and/or structured source code event inputs from various sources, such as internal bug reports from a bug tracker 246D, help center comments 246A, PUNTs 246B, CSATs 246C, and/or code changes 246E. Code changes 246E may reflect changes made to source code that underlies the software application being analyzed. In some implementations, code changes 246E (and bug reports from bug tracker 246D, where applicable) may be retrieved from a version control system VCS (not depicted) that is used to manage the source code. Code changes 246E may include raw source edits committed to the VCS, comments made when those source code edits are committed to the VCS, etc. In some, but not necessarily all implementations, these inputs may similarly be normalized and/or summarized by raw data analysis engine 122.

TQAI 250 may include, for instance, reduced dimensionality embeddings (continuous or discrete) 252A that semantically represent raw inputs contained in TQRI 140/144, textual summaries 252B of raw inputs contained in TQRI 140/144, extracted information 252C about one or more aspects of TQRI 140/144 (e.g., by comparing TQRI 140/144 with a codebase or configuration file of the software application), and/or tags applied to various topics in the raw inputs.

Raw finding engine 124 may be configured to process/synthesize TQAI 250 to generate TQRF 260. TQRF may represent higher-level insights derived from upstream TQRI 140/144. As noted above, a finding may represent an observation related to true quality of the software application. These observations may, for example, identify user pain points, satisfaction points, feature requests, regressions (e.g., a code change that “unfixes” a previous fix), questions, general perceptions of the application, and so forth. An example of a finding may be that a user reported a failure of an automated assistant to play the correct audio track.

Finding augmentation engine 126 may be configured to process/synthesize TQRFs using one or more generative models 130 to generate TQAFs 262, and/or to update existing TQAFs 262. This augmentation can add any useful information such as more specific descriptions than were contained in TQRFs, timing, trends, potential culprits/root causes, types of users affected, sentiment, relevant source code changes (which may have led to a new trend of users complaining about a feature of the software application), changes to relevant proxies/internal metrics (e.g., latency, impressions, clicks, engagement, crashes, etc.), and so forth. In some implementations, TQAFs may identify trends in the negative feedback of external TQRI 140 and/or map source code event inputs of internal TQRI 144 with temporal starting points of these trends, effectively connecting the user domain with the developer domain. For example, an input prompt assembled by finding augmentation engine 126 to include TQAI 250 may also include a command configured to condition one or more generative models to generate generative model output that maps feedback from one or more of the unstructured inputs to information about one or more respective source code events of one or more of the source code event inputs. An example of generative model output that is conditioned in this manner is demonstrated in FIG. 2, where an external TQAF-E 262A (a finding generated from TQRI 140) is shown as being coupled, paired, and/or linked with a corresponding and/or related (e.g., causal) internal TQAF-I 262B (e.g., a finding from TQRI 144).

TQAFs 262 may then be provided to GM output engine 128. GM output may or may not apply one or more generative models 130 to TQAFs 262 to generate output data, including but not limited to as HTML, XML, data to render a proprietary GUI, JSON, etc. This output data may be provided to rendering engine 114 of client device 110 for rendering.

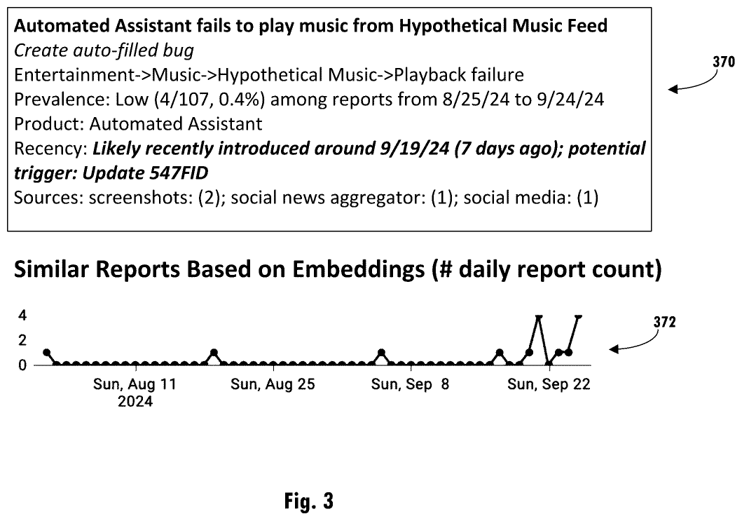

FIG. 3 depicts an example report 370 that may be rendered by rendering engine 114 and/or presented by a client device 110. In this example, report 370 provides a graphical illustration of the type of output data that may be generated by true quality analysis system 100 based on TQRI 140/144. This data presented by report 370 can include user pain points, satisfaction points, feature requests, regressions (e.g., a code change that “unfixes” a previous fix), questions, and/or general perceptions of the product, among other things.

For example, at top, a problem that has been synthesized from one or more unstructured inputs from one or more external data sources is provided as: “Automated Assistant fails to play music from Hypothetical Music Feed.” The problem is indicated to have been created using technique described herein as an “auto-filled bug.” In some implementations, a hierarchy and/or ontology of categories or topics that the problem may fall into is provided. In FIG. 3, for instance, a path of “Entertainment->Music->Hypothetical Music->Playback failure” is provided.

Various statistics may be presented about the problem. For example, in FIG. 3, the problem is reported to have a “Prevalence: Low (4/107, 0.4%) among reports from Aug. 25, 2024 to Sep. 24, 2024.” There is also a finding that identifies a mapping between negative feedback from unstructured input(s) (e.g., external TQRI 140) to information about respective source code events (e.g., internal TQRI 144). In this example, the finding is “Likely recently introduced around Sep. 19, 2024 (7 days ago); potential trigger: Update 547FID.” Various unstructured inputs that were relied upon are then provided: two screenshots, one unstructured input from a social news aggregator (e.g., from an article, post, or discussion), and one unstructured input from social media.

Report 370 also includes a visualization 372 that charts incidences of unstructured inputs (e.g., external TQRI 140) along a timeline. These unstructured inputs may have been grouped into a cluster based on semantic and/or syntactic similarity, e.g., using similarity measures such as dot product, cosine similarity, Euclidean distance, etc. It can be seen that the incidence rate is low until approximately September 19, which is what lead to the finding described previously (“Likely recently introduced around Sep. 19, 2024 (7 days ago); potential trigger: Update 547FID.”).

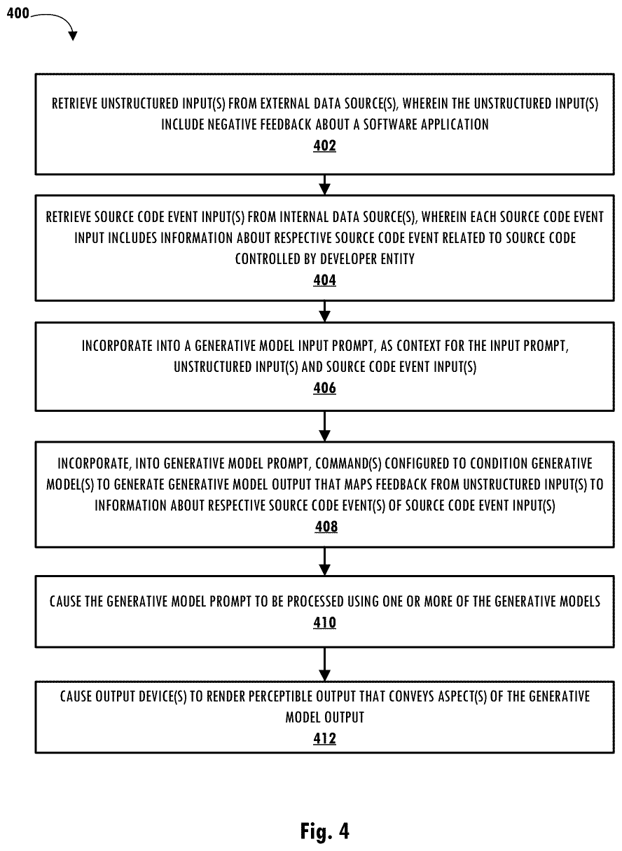

FIG. 4 depicts an example method 400 performed by true quality analysis system 100, according to various implementations. For convenience, the operations of method 400 are described with reference to a system that performs the operations. This system may include various components of a computing system, such as true quality analysis system 100 depicted in FIG. 1. Moreover, while some operations in method 400 are described as being performed in a particular order, this is not meant to be limiting. One or more operations may be performed in a different order or concurrently, and some operations may be omitted, without departing from the spirit and scope of the present disclosure.

At block 402, the system may retrieve one or more unstructured inputs (e.g., external TQRI 140) from one or more external data sources. The unstructured inputs may include (but are not limited to) negative feedback about a software application. The software application may be based on source code controlled by a developer entity and stored in one or more internal sources controlled by the developer entity. The external data sources may include, for instance, audio content aggregator 242A, social news aggregator 242B, screenshot(s) 242C, other web sources, podcasts, videos, etc. The unstructured inputs may include various data modalities such as text, images, audio, video, etc. In some implementations the unstructured inputs may include a screenshot captured of a graphical user interface (GUI) rendered by the software application, a digital image or digital video frame generated and/or rendered by the software application, etc. Additionally or alternatively, the unstructured inputs may include a user review composed in natural language and posted on one or more of the external data sources.

While techniques described herein have thus far been related to software applications rendered on client devices, this is not meant to be limiting. Techniques described herein may be used to improve other types of software, such as software that operates machines such as robots. For instance, in some implementations, the unstructured inputs may include a digital video portraying a robot engaging in one or more behaviors. The robot may be controlled at least in part by the software application under review. In such a case, the unstructured inputs may include natural language conveying negative feedback about the robot's behaviors. Techniques described herein may be used to identify this negative feedback as part of a trend and/or to map the negative feedback and/or trend to source code events (e.g., code changes) that may be the cause of the robot's undesired behavior.

At block 404, the system may retrieve one or more source code event inputs (e.g., internal TQRI 144) from one or more of the internal data sources. Each source code event input may include information about a respective source code event related to the source code controlled by the developer entity. The internal sources may include, for instance, help center feedback 246A, PUNTs 246B, CSATs 246C, bug tracker data 246D, and/or code changes 246E. The one or more source code event inputs may include, for example, an internal bug report from bug tracker 246D, an edit made to the source code from code changes 246E, a bug for which a solution was postponed from PUNTs, etc.

At block 406, the system may incorporate into a generative model prompt, as context for the generative model prompt, one or more of the unstructured inputs and one or more of the source code event inputs. For example, various modalities of data may be tokenized to create input tokens (e.g., numbers, embeddings) that can be processed using generative model(s) 130.

At block 408, the system may incorporate one or more commands into the generative model prompt. The commands may be configured to condition one or more generative models 130 to generate generative model output that maps feedback from one or more of the unstructured inputs to information about one or more respective source code events of one or more of the source code event inputs. In some implementations, one or more of the commands may be configured to condition the generative model output to predict a root cause of one or more aspects of the feedback from one or more of the unstructured inputs.

At block 410, the system may cause the generative model prompt to be processed using one or more of the generative models 130. The generative model may include a large language model (LLM), a vision language model (VLM), a diffusion model, etc.

At block 412, the system may cause one or more output devices to render perceptible output that conveys one or more aspects of the generative model output. For example, client device 110 and rendering engine 114 may be used to render report 370, including trend graph 372.

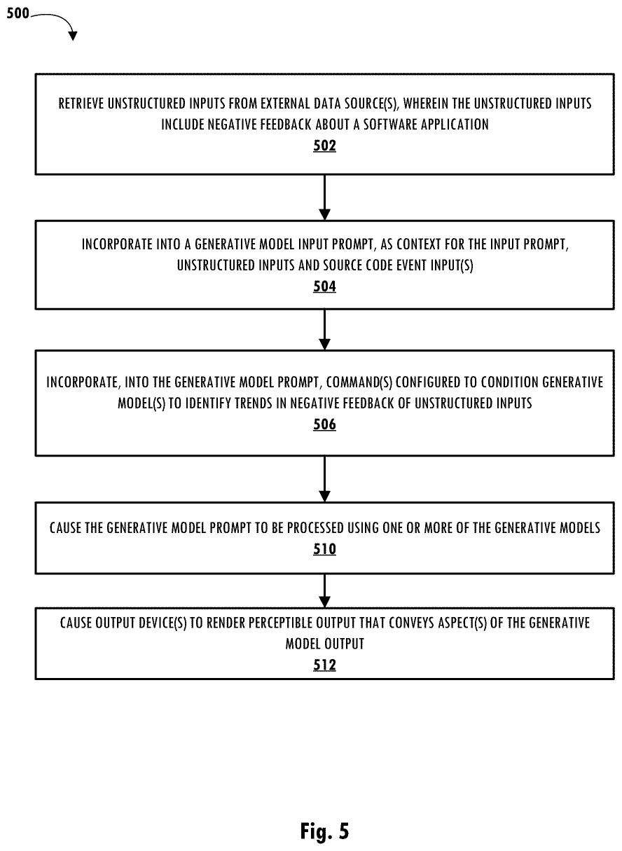

FIG. 5 depicts an example method 500 performed by true quality analysis system 100, according to various implementations. For convenience, the operations of method 500 are described with reference to a system that performs the operations. This system may include various components of a computing system, such as true quality analysis system 100 depicted in FIG. 1. Moreover, while some operations in method 500 are described as being performed in a particular order, this is not meant to be limiting. One or more operations may be performed in a different order or concurrently, and some operations may be omitted, without departing from the spirit and scope of the present disclosure.

Many aspects of method 500 share characteristics with aspects of method 400. For example, at block 502, the system may retrieve a plurality of unstructured inputs (e.g., external TQRI 140) from one or more external data sources. This is similar to block 402.

However, instead of retrieving potentially corresponding source code event inputs (like at block 404), at block 504, the system may incorporate into a generative model prompt, as context for the generative model prompt, the plurality of unstructured inputs.

At block 506, the system may incorporate one or more commands into the generative model prompt. Unlike the commands of block 408, the commands of block 506 may be configured to condition one or more generative models 130 to identify one or more trends in the negative feedback of the plurality of unstructured inputs. These trends may or may not be subsequently mapped to corresponding source code events identified via analysis of source code event inputs.

At block 510, the system may cause the generative model prompt to be processed using one or more of the generative models 130.

At block 512, the system may cause one or more output devices to render perceptible output that conveys one or more aspects of the generative model output. For example, client device 110 and rendering engine 114 may be used to render report 370, including trend graph 372.

FIG. 6 is a block diagram of an example computer system 610. Computer system 610 typically includes at least one processor 614 that communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computer system 610. Network interface subsystem 616 provides an interface to outside networks and is coupled to corresponding interface devices in other computer systems.

User interface input devices 622 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 610 to the user or to another machine or computer system.

Storage subsystem 624 stores programming and data constructs that provide the functionality of some or all of the modules described herein. For example, the storage subsystem 624 may include the logic to perform selected aspects of methods 400 and/or 500.

These software modules are generally executed by processor 614 alone or in combination with other processors. Memory 625 used in the storage subsystem 624 can include a number of memories including a main random access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by processor 614.

Bus subsystem 612 provides a mechanism for letting the various components and subsystems of computer system 610 communicate with each other as intended. Although bus subsystem 612 is shown schematically as a single bus, alternative implementations of the bus subsystem may use multiple busses.

Computer system 610 can be of varying types including a workstation, server, computing cluster, blade server, server farm, or any other data processing system or computing device. Due to the ever-changing nature of computers and networks, the description of computer system 610 depicted in FIG. 6 is intended only as a specific example for purposes of illustrating some implementations. Many other configurations of computer system 610 are possible having more or fewer components than the computer system depicted in FIG. 6.

In various implementations, a method implemented using one or more processors may include retrieving one or more unstructured inputs from one or more external data sources. The one or more unstructured inputs may include negative feedback about a software application. The software application may be based on source code controlled by a developer entity and stored in one or more internal sources controlled by the developer entity. Also, one or more source code event inputs may be retrieved from one or more of the internal data sources. Each source code event input may include information about a respective source code event related to the source code controlled by the developer entity. Furthermore, one or more of the unstructured inputs and one or more of the source code event inputs may be incorporated into a generative model prompt, as context for the generative model prompt.

One or more commands may be incorporated into the generative model prompt. The one or more commands may be configured to condition one or more generative models to generate generative model output that maps feedback from one or more of the unstructured inputs to information about one or more respective source code events of one or more of the source code event inputs. The generative model prompt may be caused to be processed using one or more of the generative models, and one or more output devices may be caused to render perceptible output that conveys one or more aspects of the generative model output.

In some implementations, one or more of the generative models may include a vision language model (VLM).

In particular implementations, one or more of the unstructured inputs may include a screenshot captured of a graphical user interface (GUI) rendered by the software application.

In further implementations, one or more of the unstructured inputs may include a digital image or digital video frame generated and/or rendered by the software application.

In certain implementations, one or more of the unstructured inputs may include a user review composed in natural language and posted on one or more of the external data sources.

In some cases, the one or more unstructured inputs may include a plurality of unstructured inputs.

In these cases, one or more of the commands may be configured to condition the generative model output to identify one or more trends in the negative feedback of the plurality of unstructured inputs.

Moreover, one or more of the commands may be configured to condition the generative model output to map one or more of the source code event inputs with a temporal starting point of one or more of the trends in the negative feedback.

Additionally or alternatively, one or more of the commands may be configured to condition the generative model output to map one or more of the source code event inputs with a temporal starting point of multiple related unstructured inputs of the plurality of unstructured inputs.

In particular implementations, one or more of the commands may be configured to condition the generative model output to predict a root cause of one or more aspects of the feedback from one or more of the unstructured inputs.

In some embodiments, one or more unstructured inputs may include a digital video portraying a robot engaging in one or more behaviors, wherein the robot is controlled at least in part by the software application.

Furthermore, one or more of the unstructured inputs may include natural language conveying negative feedback about one or more of the behaviors engaged in by the robot.

In other embodiments, a given source code event input of the one or more source code event inputs may include an internal bug report.

In such case, assigning a priority to the given source code event input, relative to one or more other source code event inputs, based on the generative model output may be further comprised.

In still further embodiments, one or more of the source code event inputs may include an edit made to the source code controlled by the developer entity.

In some implementations, one or more of the source code event inputs may include a change made to an aspect of the source code controlled by the developer entity.

In another aspect, a method implemented using one or more processors may include: retrieving a plurality of unstructured inputs from one or more external data sources, wherein the one or more unstructured inputs include negative feedback about a software application; incorporating into a generative model prompt, as context for the generative model prompt, the plurality of unstructured inputs; incorporating one or more commands into the generative model prompt, wherein the one or more commands are configured to condition one or more generative models to identify one or more trends in the negative feedback of the plurality of unstructured inputs; causing the generative model prompt to be processed using one or more of the generative models; and causing one or more output devices to render perceptible output that conveys one or more aspects of the generative model output.

In various implementations, the software application may be based on source code controlled by a developer entity. In various implementations, one or more of the commands may be configured to condition the generative model output to identify a regression in the source code by mapping one or more source code event inputs with a temporal starting point of one or more of the trends in the negative feedback. In various implementations, each source code event input may include information about a respective source code event related to the source code controlled by the developer entity. In various implementations, a given source code event input of the one or more source code event inputs may include an internal bug report. In various implementations, the method may include assigning a priority to the given source code event input, relative to one or more other source code event inputs, based on the generative model output.

In various implementations, one or more of the source code event inputs may include an edit made to the source code controlled by the developer entity. In various implementations, one or more of the source code event inputs may include a change made to an aspect of the source code controlled by the developer entity.

In various implementations, one or more of the generative models may include a vision language model (VLM). In various implementations, one or more of the unstructured inputs may include a screenshot captured of a graphical user interface (GUI) rendered by the software application. In various implementations, one or more of the unstructured inputs comprises a digital image or digital video frame generated and/or rendered by the software application.

In various implementations, one or more of the unstructured inputs may include a user review composed in natural language and posted on one or more of the external data sources. In various implementations, one or more of the unstructured inputs may include a digital video posted on one or more of the external data sources. In various implementations, one or more of the unstructured inputs may include a transcript of the digital video.

The methods described above may be implemented using a system comprising one or more processors and memory storing instructions that, when executed by the one or more processors, perform the steps outlined above. These instructions can be tangibly embodied in a transitory computer-readable medium (e.g., a propagating signal) or a non-transitory computer-readable medium (e.g., a hard drive, solid-state drive, memory chip, optical disc) storing the instructions. The system may further include input/output devices for receiving data and presenting the generated outputs.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teaching(s) is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A method implemented using one or more processors, comprising:
retrieving one or more unstructured inputs from one or more external data sources, wherein the one or more unstructured inputs include negative feedback about a software application, wherein the software application is based on source code controlled by a developer entity and stored in one or more internal data sources controlled by the developer entity;
retrieving one or more source code event inputs from one or more of the internal data sources, wherein each source code event input includes information about a respective source code event related to the source code controlled by the developer entity;
incorporating into a generative model prompt, as context for the generative model prompt, one or more of the unstructured inputs and one or more of the source code event inputs;
incorporating one or more commands into the generative model prompt, wherein the one or more commands are configured to condition one or more generative models to generate generative model output that maps feedback from one or more of the unstructured inputs to information about one or more respective source code events of one or more of the source code event inputs;
causing the generative model prompt to be processed using one or more of the generative models; and
causing one or more output devices to render perceptible output that conveys one or more aspects of the generative model output.

2. The method of claim 1, wherein one or more of the generative models comprises a vision language model (VLM).

3. The method of claim 2, wherein one or more of the unstructured inputs comprises a screenshot captured of a graphical user interface (GUI) rendered by the software application.

4. The method of claim 2, wherein one or more of the unstructured inputs comprises a digital image or digital video frame generated and/or rendered by the software application.

5. The method of claim 1, wherein one or more of the unstructured inputs comprises a user review composed in natural language and posted on one or more of the external data sources.

6. The method of claim 1, wherein the one or more of the unstructured inputs comprise a plurality of unstructured inputs.

7. The method of claim 6, wherein one or more of the commands are configured to condition the generative model output to identify one or more trends in the negative feedback of the plurality of unstructured inputs.

8. The method of claim 7, wherein one or more of the commands are configured to condition the generative model output to map one or more of the source code event inputs with a temporal starting point of one or more of the trends in the negative feedback.

9. The method of claim 6, wherein one or more of the commands are configured to condition the generative model output to map one or more of the source code event inputs with a temporal starting point of multiple related unstructured inputs of the plurality of unstructured inputs.

10. The method of claim 1, wherein one or more of the commands are configured to condition the generative model output to predict a root cause of one or more aspects of the feedback from one or more of the unstructured inputs.

11. The method of claim 1, wherein one or more of the unstructured inputs comprises a digital video portraying a robot engaging in one or more behaviors, wherein the robot is controlled at least in part by the software application.

12. The method of claim 1, wherein one or more of the unstructured inputs comprises natural language conveying negative feedback about one or more of the behaviors engaged in by the robot.

13. The method of claim 1, wherein a given source code event input of the one or more source code event inputs comprises an internal bug report.

14. The method of claim 13, further comprising assigning a priority to the given source code event input, relative to one or more other source code event inputs, based on the generative model output.

15. The method of claim 1, wherein one or more of the source code event inputs comprises an edit made to the source code controlled by the developer entity.

16. The method of claim 1, wherein one or more of the source code event inputs comprises a change made to an aspect of the source code controlled by the developer entity.

17. A system comprising one or more processors and memory storing instructions that, in response to execution of the instructions by the one or more processors, cause the one or more processors to:
retrieve one or more unstructured inputs from one or more external data sources, wherein the one or more unstructured inputs include negative feedback about a software application, wherein the software application is based on source code controlled by a developer entity and stored in one or more internal data sources controlled by the developer entity;
retrieve one or more source code event inputs from one or more of the internal data sources, wherein each source code event input includes information about a respective source code event related to the source code controlled by the developer entity;
incorporate into a generative model prompt, as context for the generative model prompt, one or more of the unstructured inputs and one or more of the source code event inputs;
incorporate one or more commands into the generative model prompt, wherein the one or more commands are configured to condition one or more generative models to generate generative model output that maps feedback from one or more of the unstructured inputs to information about one or more respective source code events of one or more of the source code event inputs;
cause the generative model prompt to be processed using one or more of the generative models; and
cause one or more output devices to render perceptible output that conveys one or more aspects of the generative model output.

18. The system of claim 17, wherein one or more of the generative models comprises a vision language model (VLM).

19. The system of claim 18, wherein one or more of the unstructured inputs comprises a screenshot captured of a graphical user interface (GUI) rendered by the software application.

20. At least one non-transitory computer-readable medium comprising instructions that, in response to execution of the instructions by one or more processors, cause the one or more processors to:
retrieve one or more unstructured inputs from one or more external data sources, wherein the one or more unstructured inputs include negative feedback about a software application, wherein the software application is based on source code controlled by a developer entity and stored in one or more internal data sources controlled by the developer entity;
retrieve one or more source code event inputs from one or more of the internal data sources, wherein each source code event input includes information about a respective source code event related to the source code controlled by the developer entity;
incorporate into a generative model prompt, as context for the generative model prompt, one or more of the unstructured inputs and one or more of the source code event inputs;
incorporate one or more commands into the generative model prompt, wherein the one or more commands are configured to condition one or more generative models to generate generative model output that maps feedback from one or more of the unstructured inputs to information about one or more respective source code events of one or more of the source code event inputs;
cause the generative model prompt to be processed using one or more of the generative models; and
cause one or more output devices to render perceptible output that conveys one or more aspects of the generative model output.
